(19) United States
(12) Patent Application Publication
(10) Pub. No.: US 2016/0259439 A1
(43) Pub. Date: Sep. 8, 2016

(54) MULTI-TOUCH KEYLESS ENTRY PAD

(71) Applicant: Ford Global Technologies, LLC, Dearborn, MI (US)

(72) Inventors: Pietro BUTTOLO, Dearborn Heights, MI (US); James Stewart RANKIN, II, Novi, MI (US); Dipanjan GHOSH, Livonia, MI (US); Gary Steven STRUMOLO, Canton, MI (US); Harry LOBO, Canton, MI (US); Kassandra RITTER, Ann Arbor, MI (US); Jessica SMITH, Roseville, MI (US); Michael M. AZZOUZ, Livonia, MI (US); Stuart C. SALTER, White Lake, MI (US)

(21) Appl. No.: 14/635,650

(22) Filed: Mar. 2, 2015

(51) Int. Cl. G06F 3/041; G06F 3/0488

(52) U.S. Cl. CPC G06F 3/041; G06F 3/04883

(57) ABSTRACT

A vehicle includes an external keypad, having a touchpad. The keypad may be configured to identify an access code according to user input to the touchpad, the access code including one of (i) a numerical value indicating a count of simultaneously pressed keys of the touchpad, and (ii) a swipe pattern including a press, slide, and release from the touchpad; and send the access code to a controller to facilitate access to a vehicle unlock user interface. The controller may direct the keypad to display the vehicle unlock user interface on the keypad when the access code matches a predefined access code stored to the controller. The keypad may display a background logo when the keypad is available to receive user input and may display a vehicle unlock user interface on the touchpad when the access code is validated.

### TECHNICAL FIELD

Aspects of the disclosure generally relate to a multi-touch keyless entry pad for vehicles.

### BACKGROUND

Keypads are generally positioned on the exterior of a vehicle and are used to lock and unlock the vehicle, among other features. The driver may unlock the door in response to successfully inputting a factory code on the keypad, which is a code including a sequence of numbers or other such characters. The driver may also use the factory code to program a new code, sometimes referred to as a personalized code, which may be easier to remember than the factory code and usable to unlock the vehicle with the keypad.

Such keypads allow the driver to unlock and lock the vehicle without the use of a key. Generally, the keypad is electrically coupled to an electronic controller. The controller controls a mechanism to unlock and lock the vehicle in response to the factory code inputted by the driver via the keypad. Other such keyless entry systems may include remote frequency based transmitters operably coupled to the electronic controller. The electronic controller is configured to unlock and lock the doors of the vehicle in response to receiving radio frequency (RF) encoded signals from the transmitters.

### SUMMARY

In a first illustrative embodiment, a vehicle includes an external keypad, having a touchpad, configured to identify an access code according to user input to the touchpad, the access code including one of (i) a numerical value indicating a count of simultaneously pressed keys of the touchpad, and (ii) a swipe pattern including a press, slide, and release from the touchpad; and send the access code to a controller to facilitate access to a vehicle unlock user interface.

In a second illustrative embodiment, a system includes a vehicle keypad, having a touchpad, configured to display a background logo when the keypad is available to receive user input; identify an access code according to user input to the touchpad; and display a vehicle unlock user interface on the touchpad when the access code is validated.

In a third illustrative embodiment, a computer-implemented method includes sending an access code, by an external keypad, to a vehicle controller to facilitate access to a vehicle unlock user interface, the access code including either a swipe pattern spanning at least two predefined regions of a touchpad on the external keypad, or a numerical value indicative of a number of simultaneously activated predefined regions of the touchpad.

### BRIEF DESCRIPTION OF THE DRAWINGS

FIG. 1 illustrates an example keyless entry system for a vehicle including a keypad;

FIGS. 2A-2B illustrate examples of the keypad receiving multi-touch user input of a number;

FIGS. 2C-2D illustrate examples of the keypad receiving swipe user input of a pattern;

FIGS. 2E-2F illustrate examples of the keypad displaying a vehicle unlock user interface;

FIG. 3 illustrates an example process for receiving multi-touch or pattern user input using the keypad; and

FIG. 4 illustrates an example process for utilizing a code or pattern input via the keypad to access the vehicle.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Some vehicle systems include a keypad having a plurality of individual sensors or buttons that each correspond to a numeric character, an alpha character or a combination of alpha-numeric characters. Using the sensors of the keypad, a user may enter in a code to unlock the vehicle.

An improved keypad may utilize a single touchpad in place of the plurality of individual sensors to provide for improved aesthetics as well as for providing additional functionality. In an example, the touchpad may be configured to recognize access codes including multi-touch finger contacts simultaneously. Other examples of improved keypads utilizing multiple touchpads are described in detail in co-pending application Ser. No. ______, filed Mar. 2, 2015, the disclosure of which is hereby incorporated in its entirety by reference herein.

For instance, if a user wishes to enter a code of ‘35234’, the user may place ‘3’ fingers on the pad, then ‘5’ fingers, then ‘2’ fingers, then ‘3’ fingers, and finally ‘4’ fingers. In some cases, when entering numbers the keypad may optionally be configured to display the current number being entered.

In another example, rather than facilities the entry of a numerical sequence, the touchpad may be utilized to enter access codes including a continuous gesture, i.e. a gesture without lifting the finger. Using the gesture access codes, the user may be able to draw a shape or other pattern that may be used to authenticate the user with the vehicle. Moreover, as the swipe touchpad also does not require numbers or other characters printed on or adjacent to it, the touchpad may also include a background logo to enhance the keypad aesthetics.

Notably, such implementations enhance keypad security, as any lingering finger smudges on the interface cannot be traced back to the entered numbers. Moreover, as the touchpad does not require numbers or other characters printed on or adjacent to it, the touchpad may instead be designed to include a background logo, such as the FORD Blue Oval logo or the Lincoln logo, to enhance the keypad aesthetics. In some cases, the keypad may display the background logo when the keypad is available to receive user input, such as when the keypad is tapped or when user proximity is detected by the vehicle (e.g., via key fob presence, via capacitive vehicle sensors, etc.).

Once the access code has been entered, e.g., via multi-touch or gesture input, the touchpad may be further configured to display a menu of available options that may be performed. In an example, once the correct combination or swipe pattern is entered, the touchpad may be backlit to show a vehicle profile (e.g., from the side or the top), with specific features highlighted for selection. These features may include, as some non-limiting possibilities, to unlock all doors, unlock a specific door, open a vehicle lift-gate, open vehicle windows, and enter valet mode. Using the vehicle profile, the user may press on any of the highlighted features to invoke the available functions. Accordingly, access to these features may be provided to the user graphically, rather than requiring the user to remember a numeric code or sequence to perform certain commands (e.g., to hold down particular numeric buttons to unlock the vehicle doors).

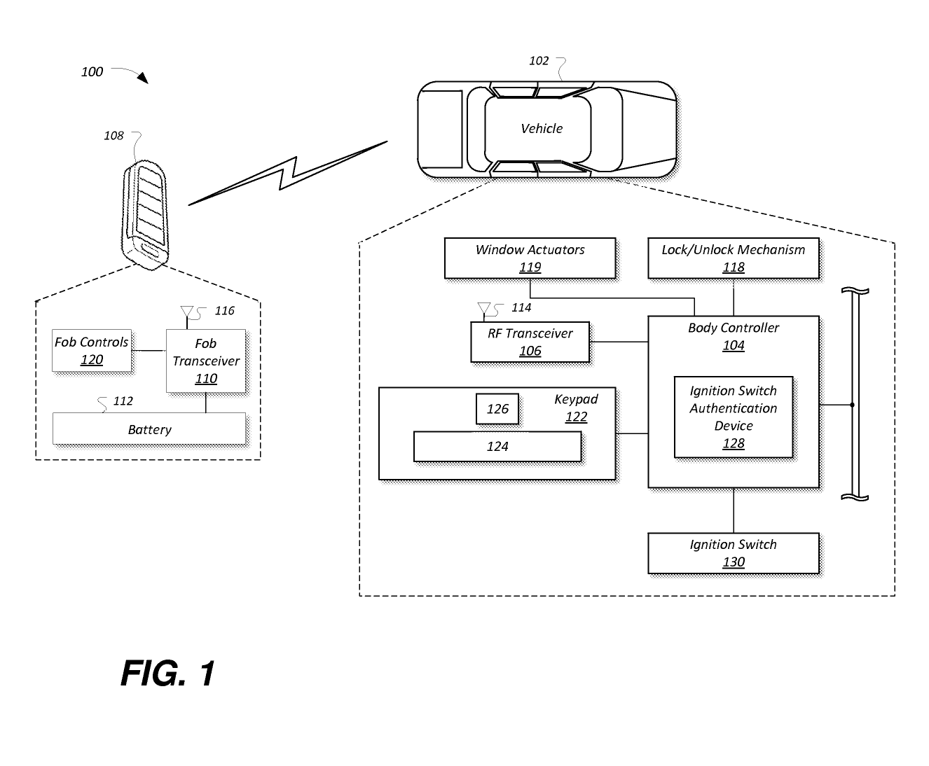

FIG. 1 illustrates an example keyless entry system 100 for a vehicle 102 having a keypad 122. The system 100 may include a body controller 104 having a radio frequency (RF) transceiver 106. A key fob 108 may be in communication with the RF transceiver 106 of the controller 104 utilizing a fob transceiver 110 powered by a battery 112. An antenna 114 of the RF transceiver 106 may receive RF signals from an antenna 116 of the fob transceiver 110, and may deliver the signals to the RF transceiver 106. An unlock/lock mechanism 118 is operably coupled to the controller 104. The controller 104 is configured to control the unlock/lock mechanism 118 to unlock/lock doors of the vehicle 102 in response to the RF signals transmitted by the key fob 108. Power window actuators 119 may also be operably coupled to the controller 104, such that the controller 104 is configured to cause the various windows (e.g., front and rear door power windows, powered window side vents, power sunroofs and moon-roofs) of the vehicle 102 to open or close. The key fob 108 may include one or more fob controls 120, such as a lock switch and an unlock switch. Accordingly, the controller 104 controls the unlock/lock mechanism 118 to lock the doors of the vehicle 102 in response to a user depressing a lock fob control 120 of the key fob 108, and to unlock the doors of the vehicle 102 in response to the user depressing an unlock fob control 120 of the key fob 108.

The keypad 122 is in electrical communication with the controller 104. The keypad 122 may be positioned on an exterior portion or section of the vehicle 102. In one example, the keypad 122 may be hardwired to the controller 104. In another example, the keypad 122 may be in RF communication with the controller 104 (e.g., via the RF antenna 114). The keypad 122 includes a touchpad 124 configured to receive user input. In some examples, the touchpad 124 may support multi-touch gestures to allow the keypad 122 to detect multiple simultaneous finger presses. Additionally or alternatively, the touchpad 124 may support swipe or other gestures, to allow the keypad 122 to detect such movements performed by the user.

In some examples, the keypad 122 may further include a separate display 126 configured to display to the user the current character being entered into the keypad 122. In other examples, the touchpad 124 may additionally or alternately include integrated display functionality on the surface of the touchpad 124, e.g., to display a logo when receiving touch input, and/or to display vehicle profile or other graphics to facilitate selection of vehicle 102 features.

In an example, the keypad 122 may transmit commands via hardwired signals to the controller 104 responsive to the user interacting with the touchpad 124. In another example, the keypad 122 may transmit commands via RF signals to the controller 104. The controller 104 controls the unlock/lock mechanism 118 to unlock/lock the doors in response to receiving the commands, e.g., two or more signals (RF or hardwired) which correspond to a valid sequence of alpha, numeric, or alpha-numeric characters.

The key fob 108 may be implemented in connection with a base remote entry system, a passive entry passive start (PEPS) system or a passive anti-theft system (PATS). With the PEPS system, the controller 104 may control the unlock/lock mechanism 118 to unlock the door in response to the controller 104 determining that the key fob 108 is a predetermined distance away from the vehicle 102. In such a case, the key fob 108 automatically (or passively) transmits encrypted RF signals (e.g., without user intervention) in order for the controller 104 to decrypt (or decode) the RF signals and to determine if the key fob 108 is within the predetermined distance and are authorized. It is to be noted that with the PEPS implementation, the key fob 108 also generate RF signals which correspond to encoded lock/unlock signals in response to a user depressing a lock fob control 120 or an unlock fob control 120. In addition, with the PEPS system, a key may not be needed to start the vehicle 102. The user in this case may be required to depress the brake pedal switch or perform some predetermined operation prior to depressing a start switch after the user has entered into the vehicle 102. In the PATS implementation, the key fob 108 may operate as a conventional key fob in order to unlock/lock the vehicle 102. With the PATS implementation, a keys (not shown) is generally needed to start the vehicle 102. The key may include a RF transmitter embedded therein to authenticate the key to the vehicle 102.

The controller 104 includes an ignition switch authentication device 128. The ignition switch authentication device 128 may also include an RF receiver (not shown) and an antenna (not shown) for receiving RF signals transmitted by the RF transmitters of the keys. It should be noted that the ignition switch authentication device 128 may be implemented as a standalone controller (or module). The ignition switch authentication device 128 is configured to authenticate the particular type of mechanism used to start the vehicle 102. For example, with the PATS implementation, the key is inserted into an ignition switch 130 to start the vehicle 102. In such a case, the RF transmitter of the key transmits RF signals having encrypted data therein to the receiver of the ignition switch authentication device 128. The ignition switch authentication device 128 decrypts the data to authenticate the key prior to allowing the user to start the vehicle 102.

With the PEPS implementation, as noted above, a key is not needed to start the vehicle 102. In such a case, the ignition switch authentication device 128 authenticates the RF encrypted data passively transmitted by the transmitter 108a-108n to allow the user to start the engine of the vehicle 102. As noted above, in addition to the authentication device 128 authenticating the RF encrypted data, the user may perform a predetermined operation (e.g., pull handle of a door, or open door, toggle the brake pedal switch, or other operation) prior to depressing a start switch to start the vehicle 102. The system 100 contemplates a number of other operations from those listed prior to depressing the start switch to start the vehicle 102.

As mentioned above, the touchpad 124 may implement multi-touch technology configured to recognize multiple finger contacts and receive access codes entered by the user. To enter a number, rather than pressing a switch of the keypad 122 assigned to the number, the user may instead simultaneously press a number of fingers to the touchpad 124 corresponding to the desired number. Thus, to enter a digit of an access code, such as a personal code or factory code, the user may simply touch the touchpad 124 with a desired number of fingers, at various locations of the touchpad 124. As an access code may be entered via the keypad 122 using arbitrary locations across the touchpad 124, it may be difficult for the unauthorized user to learn the user's code merely by watching. Moreover, as the touchpad 124 may receive numerical input according to a number of touches or may receive other gesture input, numbers or other indications need not be placed on or near the touchpad 124 of the keypad 122, improving keypad 122 aesthetics.

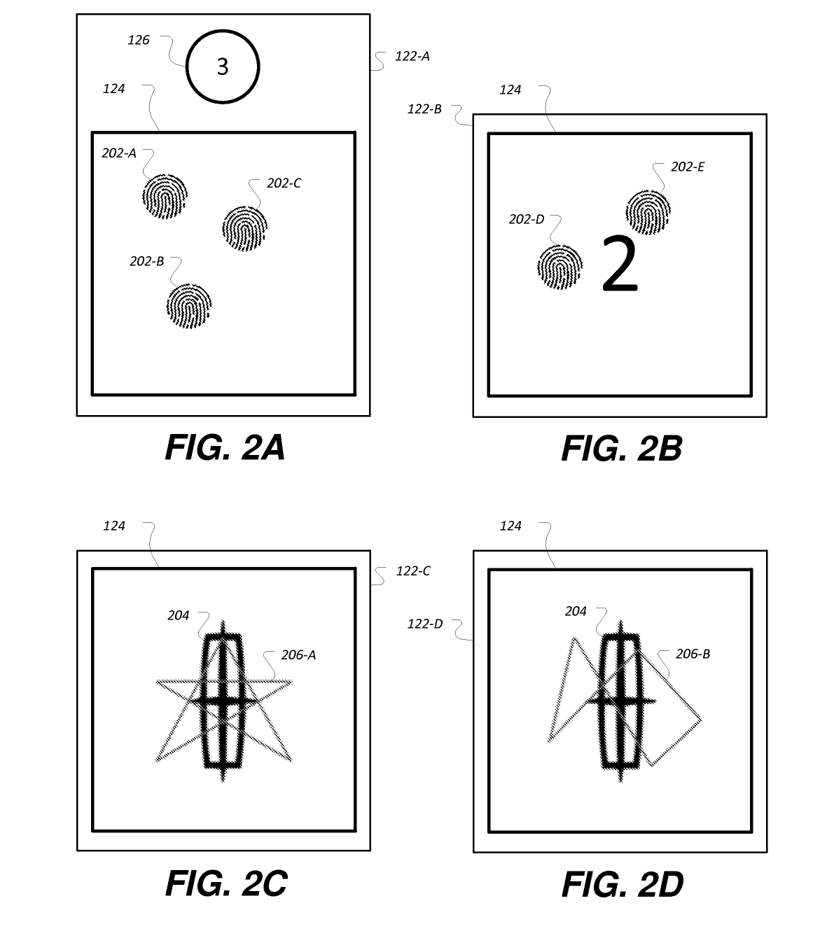

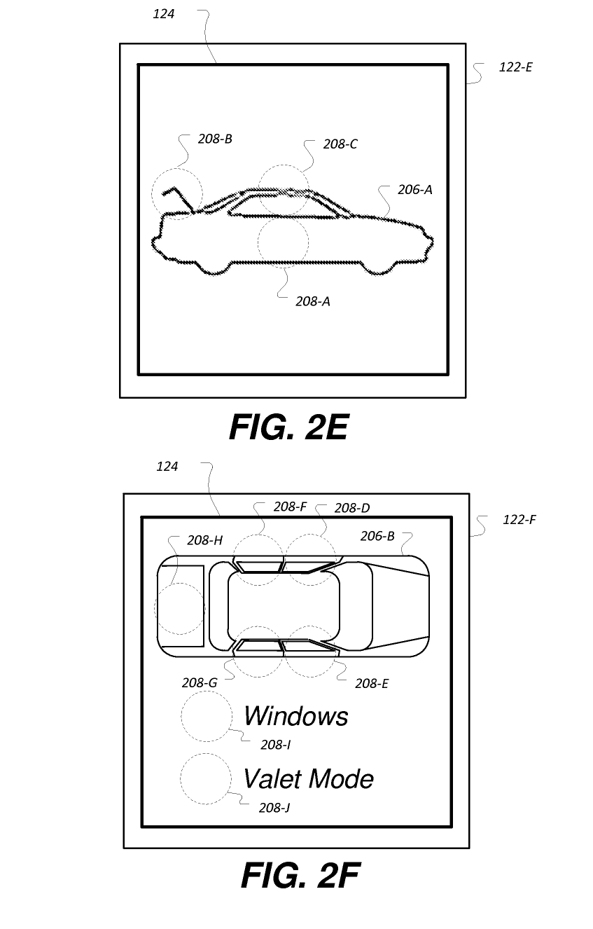

FIG. 2A illustrates an example of a keypad 122-A receiving multi-touch user input of a number. As shown, the keypad 122-A includes a touchpad 124 and a display 126 element, all in a relatively upright orientation suitable for vertical use on a B-pillar or elsewhere on the exterior of the vehicle 102. Also as shown, the user is pressing the touchpad 124 at three locations with three fingers (e.g., at contact 202-A, contact 202-B, and contact 202-C), and the display 126 indicates a ‘3’ to provide feedback of the entered number to the user. Variations on the design of the keypad 122-A are possible. For instance, keypads 122 may be implemented having larger, smaller, or differently-shaped touchpads 124. Additionally or alternately, some keypads 122 may include a display 126 in a different location relative to the touchpad 124, or may exclude the display 126 entirely.

FIG. 2B illustrates an alternate example of a keypads 122-B receiving multi-touch user input of a number. As compared to the keypad 122-A, the keypad 122-B includes integrated display 126 functionality within the touchpad 124 itself. As shown, the user is pressing the touchpad 124 with two fingers (e.g., at contact 202-D and contact 202-E), and the touchpad 124 itself indicates a ‘2’ to provide feedback of the entered number to the user.

When the user releases the touchpad 124 of the keypad 122, the number may be considered to be entered by the keypad 122, and may be provided to the controller 104 for processing.

FIG. 2C illustrates an example keypad 122-C receiving a swipe gesture 206-A and displaying a background image 204. FIG. 2D illustrates an alternate example keypad 122-D receiving a swipe gesture 206-B and displaying the background image 204. As shown in each example, the background image 204 is a logo of the vehicle 102. In other examples, the background image 204 may be another type of image (e.g., an image of the vehicle, an arbitrary image, a user selectable image, etc.), or the image may be omitted entirely. Also as shown, the user has entered the swipe gesture 206-A via the touchpad 124 of keypad 122-C, and the swipe gesture 206-B via the touchpad 124 of keypad 122-D. The gestures 206-A and 206-B (collectively 206) are illustrations of paths made by the user. These and other gestures 206 may be performed by the user, for example, by pressing a finger down on the touchpad 124, moving the finger to trace a desired pattern, and then releasing the finger from the touchpad 124. In some examples, to facilitate ease of entry of the swipe gesture 206, the user may utilize locations of aspects of the background image 204 as visual cues to guide proper entry of the swipe gesture 206. In some examples, the touchpad 124 may include integrated display 126 functionality such that the swipe gesture 206 may be illustrated on the touchpad 124.

When the user releases the touchpad 124 of the keypad 122, the gesture may be considered to be entered by the keypad 122, and may be provided to the controller 104 for processing.

The controller 104 may accordingly receive numeric or gesture input from the touchpad 124, and validate the input to determine whether the user should be granted access to a vehicle 102 unlock user interface. In an example, the controller 104 may be configured to maintain a factory code installed to the controller 104 as built, and/or one or more personal codes set up by a user authenticated using the factory code. Using the maintained codes, the controller 104 may be configured to evaluate received numeric input to determine whether a valid code was entered. If a valid code was entered, the controller 104 may be configured to enable a vehicle 102 unlock user interface displayed via the keypad 122.

In another example, the controller 104 may be configured to maintain one or more swipe patterns programmed to the controller 104 via user input. For instance, once the user is authenticated via entering a valid numeric code or previously programmed swipe pattern, the keypad 122 may include an option through which the user may set up a new access code, such as a numeric code or swipe pattern. Using the maintained swipe pattern or patterns, the controller 104 may be configured to evaluate received swipe input to determine whether a valid swipe pattern was entered. If a valid swipe pattern was entered, the controller 104 may be configured to enable the vehicle 102 unlock user interface displayed via the keypad 122.

In some examples, the vehicle 102 unlock user interface may be provided to the user via the keypad 122 by allowing for entry of predefined numbers or swipe patterns. For instance, the controller 104 may be configured to unlock the doors responsive to receiving a press of two fingers to the touchpad 124 of the keypad 122, and to unlatch the trunk responsive to receiving a press of three fingers touchpad 124 of the keypad 122. Or, the controller 104 may be configured to unlock the doors responsive to receiving an upward swipe, and to unlatch the trunk responsive to receiving a swipe towards the rear of the vehicle. In yet further examples, the vehicle 102 unlock user interface may be made available visually via the keypad 122. In yet further examples, the keypad 122 may display a user interface graphically depicting the available unlock commands.

FIG. 2E illustrates an example keypad 122-E including a display of vehicle 102 unlock user interface. The example display may be provided, for example, responsive to the controller 104 validating that the user entered a valid code or swipe pattern into the keypad 122. As shown, the keypad 122-E includes a touchpad 124 that is illuminated to display a vehicle side profile 206-A with highlights 208 configured to receive user touch input and to activate specific vehicle 102 features upon selection.

For instance, the vehicle profile 206-A includes a highlight 208-A that, when selected by a user, is configured to cause the keypad 122 to send a command to the controller 104 requesting that vehicle 102 doors be unlocked. In another example, upon a first press of the highlight 208-A, the keypad 122 may send a command to the controller 104 requesting that the driver door be unlocked, while a second press of the highlight 208-A may cause the keypad 122 to send a command to the controller 104 requesting that all doors be unlocked.

The vehicle profile 206-A may also include a highlight 208-B, that when selected by the user, causes the keypad 122 to send a command to the controller 104 requesting that the trunk be unlatched. The vehicle profile 206-A may also include a highlight 208-C, that when selected by the user, causes the keypad 122 to send a command to the controller 104 requesting that the vehicle 102 windows be lowered. In another example, a first selection of the highlight 208-C may cause the keypad 122 to request that the driver's side window be lowered, and a second selection of the highlight 208-C may cause the keypad 122 to request that all the windows be lowered.

FIG. 2F illustrates an alternate example keypad 122-F displaying vehicle 102 unlock user interface. Similar to the display illustrated with respect to the keypad 122-E, the keypad 122-F display may be provided responsive to the controller 104 validating that the user entered a valid code or swipe pattern into the keypad 122. As shown, the keypad 122-E includes a touchpad 124 that is illuminated to display a vehicle overhead profile 206-A with highlights 208 configured to receive user touch input and to activate specific vehicle 102 features upon selection.

For instance, the vehicle profile 206-B includes highlights 208-D, 208-E, 208-F, and 208-G that, when selected by a user, are each configured to cause the keypad 122 to send a command to the controller 104 that the selected vehicle 102 door be unlocked. The vehicle profile may also include a highlight 208-H that, that when selected by the user, causes the keypad 122 to send a command to the controller 104 requesting that the trunk be unlatched.

The vehicle profile 206-B may also include additional highlights 208 that are not displayed over the overlay of the vehicle profile 206-B itself. In an example, the vehicle profile 206-B may include a highlight 208-I that, when selected by the user, toggles the effect of the highlights 208-D, 208-E, 208-F, and 208-G between unlocking the vehicle 102 doors and lowering the vehicle 102 windows. In another example, the vehicle profile 206-B may include a highlight 208-J that, when selected by the user, causes the keypad 122 to send a command to the controller 104 requesting that the vehicle 102 be placed into valet mode. Valet mode may refer to a mode in which access to personal vehicle 102 information and certain vehicle 102 settings may be disabled until a passcode (e.g., a 4 digit pin) or a swipe pattern programmed to the vehicle 102 is re-entered into the vehicle 102. In some examples, when transitioning the vehicle 102 into valet mode, the keypad 122 may be configured to receive the passcode or swipe code from the user, in one of the manners discussed above, to be re-entered into the keypad 122 at a later time to remove the vehicle 102 from the valet mode.

It should be noted that the specific commands and layout of the vehicle profiles 206-A and 206-B are merely exemplary, and different implementations may utilize different layouts and available commands.

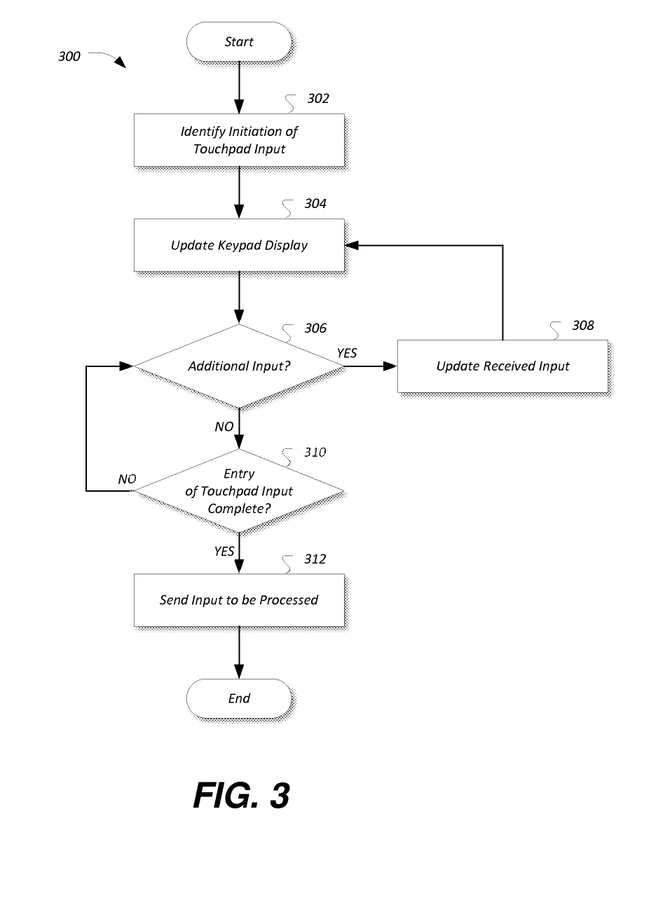

FIG. 3 illustrates an example process 300 for receiving touchpad 124 user input using the keypad 122. The process 300 may be performed, for example, by a keypad 122 such as one or more of the keypads 122-A through 122-F illustrated above with respect to FIGS. 2A-2F.

At operation 302, the keypad 122 identifies initiation of touchpad 124 input. In an example, the keypad 122 may detect the initiation by a signal received from the touchpad 124 of the keypad 122 indicating that the user has pressed one or more fingers onto the touchpad 124.

At operation 304, the keypad 122 updates the keypad display 126. In examples where the keypad display 126 is present and enabled, the keypad 122 may update the keypad display 126 to indicate the value of the currently entered input character. For instance, when a multi-touch input character is initiated by a user pressed down on the touchpad 124, the keypad 122 may determine that the value is ‘1’, and may direct the keypad display 126 to display the numeral ‘1’. In another example, when a multi-touch input character is initiated by a user pressed down three fingers onto the touchpad 124, the keypad 122 may determine that the value is ‘3’, and may direct the display 126 to show the numeral ‘3’. In yet another example, responsive to the user pressing and beginning to swipe a finger across the touchpad 124, the keypad 122 may determine that a swipe pattern is being entered, and may direct the keypad display 126 (e.g., for a touchpad 124 with integrated display capabilities) to display information related to the swipe gesture, such as a trail of the finger movement (e.g., as illustrated in Figured 2C and 2D).

At operation 306, the keypad 122 determines whether additional input was provided to the touchpad 124 that would require an update to the keypad display 126. In an example, when entering a swipe pattern, such as shown in FIG. 2C or 2D, when the user continues to create the swipe pattern without releasing the finger, the keypad 122 may determine that the gesture input continues. In an example of a multi-touch scenario, when the user additionally presses an additional finger to the touchpad 124 without releasing the currently pressed fingers to the touchpad 124, the keypad 122 may determine that an increment may be required to the input value. In another example of a multi-touch scenario, when the user releases from pressing one of the fingers from the touchpad 124 that are currently being pressed, the keypad 122 may determine that a decrement may be required to the input value. If additional input was provided to the touchpad 124 that requires an update to the display 126, such as a change in the value or trail of the finger movement, control passes to operation 308. Otherwise, control passes to operation 310.

At operation 308, the keypad 122 updates the received input. For instance, responsive to the user continuing the swipe pattern, pressing additional fingers to the touchpad 124, or releasing some of the currently pressed fingers from the touchpad 124, the keypad 122 updates the input in accordance with the currently swiped or simultaneously pressed value. After operation 308, control returns to operation 304 to update the keypad display 126.

At operation 310, the keypad 122 determines whether entry of the touchpad 124 input is complete. In an example, when the keypad 122 determines that all of the fingers have been released from the touchpad 124, control passes to operation 312. In another example, when the keypad 122 detects that there has been no change to the input for a keypad 122 timeout value (e.g., one second, two seconds, etc.), the keypad 122 considers the input to be complete and control passes to operation 312. Otherwise, control returns to operation 306 to determine whether additional input has been provided.

At operation 312, the keypad 122 sends the entered input to be processed. In an example, the keypad 122 may transmit the entered input to the controller 104 via a wired or wireless connection. After operation 312, the process 300 ends.

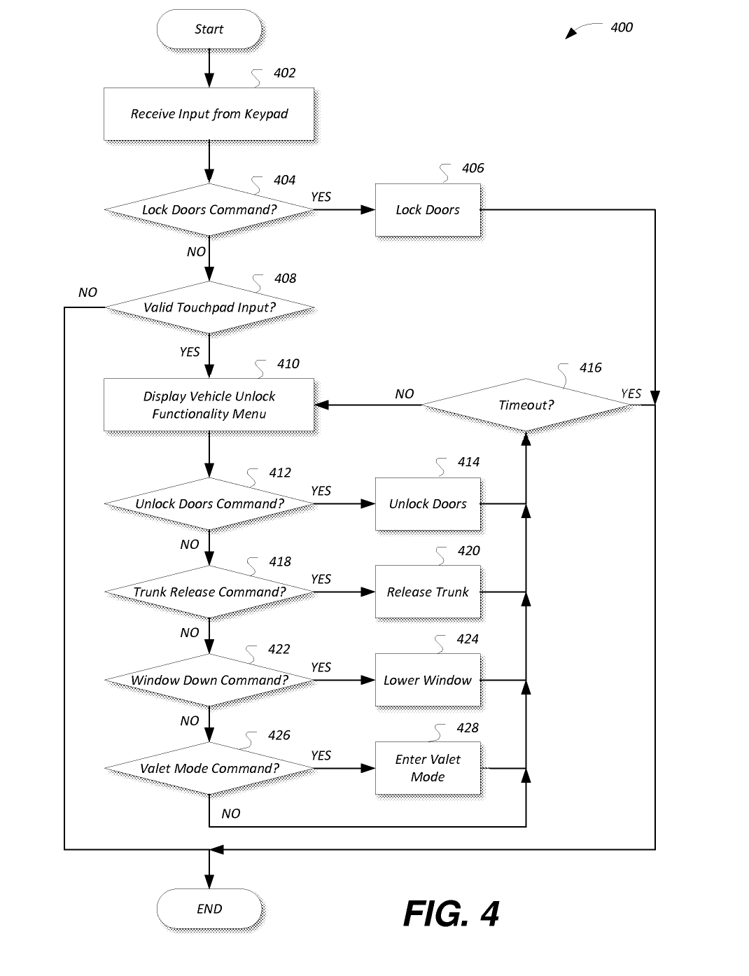

FIG. 4 illustrates an example process 400 for utilizing a code or pattern input via the keypad 122 to access the vehicle 102.

At operation 402, the controller 104 receives input from the keypad 122. In an example, the input may be entered into the multi-touch keypad 122 using the touchpad 124 of the keypad 122 according to the process 300. The input may include an access code, a portion of an access code, or a command being entered to the vehicle 102.

At operation 404, the controller 104 determines whether a lock doors command was input to the keypad 122. In an example, the lock doors command may be specified by a user pressing and holding two of fingers to the touchpad 124 of the keypad 122, or swiping down or in another predetermined pattern configured to define a lock command. As shown, the lock doors command may be entered without a user having to enter an access code (e.g., a personal code, a swipe pattern, etc.), but it should be noted that in other examples the access code may be required for the lock command. If the lock doors command is input, control passes to operation 406.

At operation 406, the controller 104 locks the vehicle 102 doors. In an example, the controller 104 may command the unlock/lock mechanism 118 to lock the doors of the vehicle 102. After operation 406, the process 400 ends.

At operation 408, the controller 104 determines whether an access code was input to the keypad 122. In an example, the controller 104 may determine whether the input (or an accumulation of recent input, e.g., digits) matches a previously set up personal code, swipe pattern, or factory code or factory pattern included in the controller 104 as shipped. If an access code is entered, control passes to operation 410. Otherwise, the process 400 ends.

At operation 410, the controller 104 displays the vehicle unlock user interface. In an example, once authenticated using the access code, the controller 104 may direct the keypad 122 to display the vehicle unlock user interface. FIGS. 2E and 2F illustrate example vehicle unlock user interfaces. Using the vehicle unlock user interface, the user may enter an unlock command to be performed by the vehicle 102.

At operation 412, the controller 104 determines whether an unlock doors command was input to the keypad 122. In an example, the unlock doors command may be specified by a user pressing an area defined by the vehicle unlock user interface as being for the unlock command. As one example, the user may press the highlight 208-A unlock area of the user interface illustrated in FIG. 2E. As another example, the user may press one or more of the door areas of FIG. 2E (e.g., highlights 208-D, 208-E, 208-F, 208-G when the display is in door unlock mode and not window mode). If the unlock doors command was entered, control passes to operation 414. Otherwise, control passes to operation 418.

At operation 414, the controller 104 unlocks the vehicle 102 doors. In an example, the controller 104 may command the unlock/lock mechanism 118 to unlock the doors of the vehicle 102.

At operation 416, the controller 104 determines whether a predetermined timeout for display of the vehicle unlock user interface has expired. The timeout may be set to, for example, one second, three seconds, five seconds, or another value sufficient to allow the user to provide input, but also to allow for the vehicle unlock user interface to be removed and not remain active for later unauthorized users. If the timeout has not expired, control returns to operation 410. Otherwise, the process 400 ends.

At operation 418, the controller 104 determines whether a trunk release command was input to the keypad 122. In an example, the trunk release command may be specified by a user pressing an area defined by the vehicle unlock user interface as being for the unlock command. As one example, the user may press the highlight 208-B trunk release area of the user interface illustrated in FIG. 2E. As another example, the user may press the highlight 208-H trunk release area of the user interface illustrated in FIG. 2F. If the trunk release command was entered, control passes to operation 420. Otherwise, control passes to operation 422.

At operation 420, the controller 104 releases the vehicle 102 trunk latch. In an example, the controller 104 may command the unlock/lock mechanism 118 to release the trunk latch of the vehicle 102. After operation 420, control passes to operation 416.

At operation 422, the controller 104 determines whether a window down command was input to the keypad 122. In an example, the window down command may be specified by a user pressing an area defined by the vehicle unlock user interface as being for the window down command. As one example, the user may press the highlight 208-I of the user interface illustrated in FIG. 2F, and then press one or more of the door areas of FIG. 2F (e.g., highlights 208-D, 208-E, 208-F, 208-G) now that the display is in window mode and not door unlock mode). If the window down command was entered, control passes to operation 424. Otherwise, control passes to operation 416.

At operation 424, the controller 104 lowers the vehicle 102 window. In an example, the controller 104 may command power window actuators 119 configured to cause the specified window or windows (e.g., front and rear door power windows, powered window side vents, power sunroofs and moon-roofs) of the vehicle 102 to open. After operation 424, control passes to operation 416.

At operation 426, the controller 104 determines whether a valet mode command was input to the keypad 122. In an example, the valet mode command may be specified by a user pressing an area defined by the vehicle unlock user interface as being for the valet mode command, such as the area 208-J of the user interface illustrated in FIG. 2E. Upon pressing the area 208-J, the user may optionally be directed to utilize the keypad 122 to enter a valet access code that must be re-entered to remove the vehicle 102 from valet mode. In other example, the access code used to display the vehicle unlock user interface may be the access code to be entered to remove the vehicle 102 from valet mode. If the valet mode command was entered, control passes to operation 428 to enter the valet mode. Otherwise, control passes to operation 416.

At operation 428, the controller 104 enters the valet mode. Once in valet mode, personal vehicle 102 information and certain vehicle 102 settings may be disabled. After operation 428, control passes to operation 416.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A vehicle comprising:
an external keypad, having a touchpad, configured to
identify an access code according to user input to the touchpad, the access code including one of (i) a numerical value indicating a count of simultaneously pressed keys of the touchpad, and (ii) a swipe pattern including a press, slide, and release from the touchpad; and
send the access code to a controller to facilitate access to a vehicle unlock user interface.

2. The vehicle of claim 1, further comprising the controller, configured to:
receive the access code from the keypad; and
direct the keypad to display the vehicle unlock user interface on the keypad when the access code matches a predefined access code stored to the controller.

3. The vehicle of claim 2, wherein the keypad is further configured to display the vehicle unlock user interface by illuminating a keypad backlight.

4. The vehicle of claim 1, wherein the controller is further configured to direct the keypad to discontinue display of the vehicle unlock user interface upon receiving no user input to the keypad within a predetermined timeout period.

5. The vehicle of claim 1, wherein the vehicle unlock user interface includes a vehicle profile overlaid with a plurality of vehicle unlock features highlighted for selection.

6. The vehicle of claim 5, wherein the vehicle unlock features include at least two of unlock vehicle doors, release vehicle trunk latch, and unroll vehicle windows.

7. The vehicle of claim 1, wherein the keypad is further configured to display the numerical value.

8. The vehicle of claim 1, wherein the keypad is further configured to at least one of: (i) increase the numerical value responsive to receiving an additional simultaneous finger press to the touchpad; and (ii) decrease the numerical value responsive to receiving a removal of a simultaneous finger press to the touchpad without releasing all of the plurality of switches that are simultaneously pressed by the user.

9. The vehicle of claim 8, wherein the keypad is further configured to display the numerical value, as incremented or decremented, to update the user.

10. The vehicle of claim 1, wherein the keypad is further configured to display a background logo when receiving the access code.

11. A system comprising:
a vehicle keypad, having a touchpad, configured to
display a background logo when the keypad is available to receive user input;
identify an access code according to user input to the touchpad; and
display a vehicle unlock user interface on the touchpad when the access code is validated.

12. The system of claim 11, wherein the access code includes one of (i) a numerical value indicating a count of simultaneous presses to the touchpad, and (ii) a swipe pattern including a press, movement, and release from the touchpad.

13. The system of claim 11, further comprising a controller, configured to:
receive the access code from the keypad; and
direct the keypad to display the vehicle unlock user interface on the keypad when the access code matches a predefined access code stored to the controller.

14. The system of claim 11, wherein the vehicle unlock user interface includes a vehicle profile overlaid with a plurality of vehicle unlock features highlighted for selection, and the vehicle unlock features include at least two of unlock vehicle doors, release vehicle trunk latch, and unroll vehicle windows.

15. A computer-implemented method comprising:
sending an access code, by an external keypad, to a vehicle controller to facilitate access to a vehicle unlock user interface, the access code including either a swipe pattern spanning at least two predefined regions of a touchpad on the external keypad, or a numerical value indicative of a number of simultaneously activated predefined regions of the touchpad.

16. The method of claim 15, further comprising:
receiving, by the controller, the access code from the keypad; and
directing the keypad, by the controller, to display the vehicle unlock user interface on the keypad when the access code matches a predefined access code stored to the controller.

17. The method of claim 15, further comprising displaying the vehicle unlock user interface by illuminating a keypad backlight.

18. The method of claim 15, farther comprising directing the keypad to discontinue display of the vehicle unlock user interface upon receiving no user input to the keypad within a predetermined timeout period.

19. The method of claim 15, wherein the vehicle unlock user interface includes a vehicle profile overlaid with a plurality of vehicle unlock features highlighted for selection, and the vehicle unlock features include at least two of unlock vehicle doors, release vehicle trunk latch, and unroll vehicle windows.
